(19) United States
(12) Patent Application Publication
(10) Pub. No.: US 2010/0012350 A1
(43) Pub. Date: Jan. 21, 2010

(54) Reinforcing Support Element For A Resilient Sheath

(76) Inventors: Markus Hardi, Neubiberg (DE); Thilo Simonsohn, Munich (DE)

Correspondence Address: BARLEY SNYDER, LLC, 1000 WESTLAKES DRIVE, SUITE 275, BERWYN, PA, 19312, US

(21) Appl. No.: 12/503,536

(22) Filed: Jul. 15, 2009

(30) Foreign Application Priority Data
Jul. 15, 2008 (DE) 10 2008 033157.0

(51) Int. Cl. H01B 7/00; B23P 11/00

(52) U.S. Cl. 174/135; 29/428

(57) ABSTRACT

The present invention relates to a support element for a resilient sheath, in particular to a holdout for a cable sleeve. The support element includes a tubular expansion element, which can be brought into contact with an inner wall of the resilient sheath and is constructed in such a way as to hold the resilient sheath in a pre-mounted radially expanded state. A reinforcing member is provided to reinforce the support element and in the pre-assembled state of the resilient sheath is at least partially received in the expansion element to reinforce the internal diameter of said expansion element, the reinforcing member being constructed in such a way that it can be removed from the expansion element before the assembly of the resilient sheath without being destroyed.

### CROSS-REFERENCE TO RELATED APPLICATIONS

This application claims the benefit of the filing date under 35 U.S.C. §119(a)-(d) of German Patent Application No. DE 10 2008 033157.0, filed Jul. 15, 2008.

### FIELD OF THE INVENTION

The present invention relates to a support element for a resilient sheath, in particular to a holdout for a cable sleeve.

### BACKGROUND

Cold-shrink sleeves or cover tubes are often used when connecting cables or repairing defective locations, or at junctions. They are made from a resilient material, for example a silicone rubber, which is positioned over the region to be covered, for example the connection region of two cables, in a pre-expanded state and then returned from the pre-expanded state to the original size thereof, which is selected in such a way that the cold-shrink sleeve can be sealed off for example from a cable jacket.

To hold a resilient sheath of this type in the pre-expanded state, it is known to mount the sheath in the expanded state on a substantially tubular support, which is known as a holdout. The support, for example, may consist of a helically wound strip, which is wound in such a way as to form a tube having a diameter greater than a diameter of the resilient sheath in the relaxed state. In this radially expanded state, the resilient sheath is positioned over the cable, which may be a power cable or a telecommunications cable, and the support is removed from the inside of the sheath by continuously pulling out the strip. It is, as a practical matter worthwhile, to form the wound holdout to be as thin as possible, because a lot of waste is produced during the removal. This minimizes increases in the cost of assembly, while also minimizing an increase in the expansion rate due to wall thickness.

Moreover, the internal diameter of the pre-expanded sheath should be as small as possible, in order to minimize the stretching forces exerted on the sheath. This means that the internal diameter of the support is selected in such a way that it just fits over the external diameter of the arrangement to be covered.

However, these known spiral holdouts present a problem, in that the internal diameter of the holdout deforms from the original circular cross-section to an oval cross-section after the resilient sheath has been mounted. This means that the internal cross-section, as in the case of an ellipse, now has a semi-major axis distance greater than the desired original radius, and a semi-minor axis distance smaller than the original radius plus the space required for pulling the strip through.

This means that the construction set can no longer be slid over the outer diameter of the round region to be covered. This described effect occurs directly after the pre-expanded sheath is mounted on the holdout, even at room temperature. It may thus be observed that an inner diameter of known holdouts may reduce from an original 84 mm to between 75 and 78 mm as a result of this type of flattening effect. Further, deformation increases over time. For many applications, a minimum value of 80 mm is required for example.

To avoid deformations in spiral holdouts of this type, it is known from U.S. Pat. No. 5,844,170 to provide a second spiral holdout which is arranged in the interior of the primary holdout in order to support it. This secondary holdout, as it is known, is only removed just before assembly.

The known solution has a disadvantage, in that the secondary holdout is also a spiral which must be removed by being pulled out and thus produces a comparatively large amount of waste. Secondly, a comparatively stable and therefore expensive spiral is used to provide sufficient support. Furthermore, the required disassembly of the secondary holdout spiral significantly increases assembly times if very long regions are to be supported. Therefore, in the known arrangement, a secondary spiral is also not provided over the entire region, but only in a tightly delimited region with an increased load.

Therefore, there is a need to provide a support element for a resilient sheath, in particular for application in cable sleeve construction sets, which is dimensionally stable and can be produced at low cost and keeps the assembly time as low as possible. There is furthermore a need for a solution which produces little waste, and is therefore environmentally friendly.

### SUMMARY

The invention has been made in view of the above problems, and provides a cable sleeve construction set in which a cable sleeve is held in the pre-expanded state by a support sleeve having an expansion element which is further supported by a reinforcing member.

The support element for a resilient sheath includes a tubular expansion element and a reinforcing member. The expansion element can be brought into contact with an inner wall of the resilient sheath and is formed in such a way as to hold the resilient sheath in a pre-assembled radially expanded state. The reinforcing member, which in the pre-assembled state of the resilient sheath, is at least partially received in the expansion element to reinforce and support the internal diameter of the expansion element, is constructed in such a way that it can be removed from the expansion element before the assembly of the resilient sheath without being destroyed.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a front view of a reinforcing member, according to an embodiment of the present invention;

FIG. 2 is a sectional view of the reinforcing member taken along the line 2-2 of FIG. 1;

FIG. 3 is a detailed view of the reinforcing member of FIG. 1;

FIG. 4 is a detailed view of an aperture shown in FIG. 2;

FIG. 5 is a detailed view of another aperture shown in FIG. 2;

FIG. 6 is a view of a reinforcing member, according to another embodiment of the present invention;

FIG. 7 is a sectional view of the reinforcing member of FIG. 6;

FIG. 8 is a detailed view of the reinforcing member of FIG. 6;

FIG. 9 is a detailed view of an aperture shown in FIG. 7;

FIG. 10 is a detailed view of another aperture shown in FIG. 7;

FIG. 11 is a sectional view of a further shape of a reinforcing member, according to another embodiment of the present invention;

FIG. 12 is a sectional view of a further shape of a reinforcing member, according to another embodiment of the present invention;

FIG. 13 is a sectional view of a further shape of a reinforcing member, according to another embodiment of the present invention;

FIG. 14 is a sectional view of a further shape of a reinforcing member, according to another embodiment of the present invention;

FIG. 15 is a sectional view of a further shape of a reinforcing member, according to another embodiment of the present invention;

FIG. 16 is a sectional view of a further shape of a reinforcing member, according to another embodiment of the present invention;

FIG. 17 is a sectional view of a further shape of a reinforcing member, according to another embodiment of the present invention;

FIG. 18 is a sectional view of a further shape of a reinforcing member, according to another embodiment of the present invention;

FIG. 19 is a perspective view of a cable sleeve construction kit in a pre-assembled state;

FIG. 20 is a front view of the cable sleeve construction kit shown in FIG. 19;

FIG. 21 is a perspective view of the cable sleeve construction kit of FIG. 19 illustrating the removal of a reinforcing member according to the invention;

FIG. 22 is a perspective view a cable sleeve construction kit illustrating further removal of the reinforcing member according to the invention;

FIG. 23 is a front view of a pre-assembled cable sleeve construction set according to another embodiment of the present invention;

FIG. 24 is a perspective view of the pre-assembled cable sleeve construction set shown in FIG. 23;

FIG. 25 is a detailed view of a reinforcing member with a movable reinforcing rib held by support legs;

FIG. 26 is a detailed view of the reinforcing member shown in FIG. 25 after the removal of the support legs;

FIG. 27 is a detailed view of another reinforcing member having a removable reinforcing rib;

FIG. 28 is a detailed view of a longitudinally divided reinforcing member according to the invention.

### DETAILED DESCRIPTION OF THE EMBODIMENT(S)

Hereinafter, exemplary embodiments of the present invention will be described in detail with reference to the accompanying drawings. Like components will be provided with like reference numerals and like component names. Furthermore, some features or combinations of features from the various embodiments shown and described may be independent inventive solutions or solutions according to the invention. Therefore, respective elements of the embodiment may be exaggerated in the drawings.

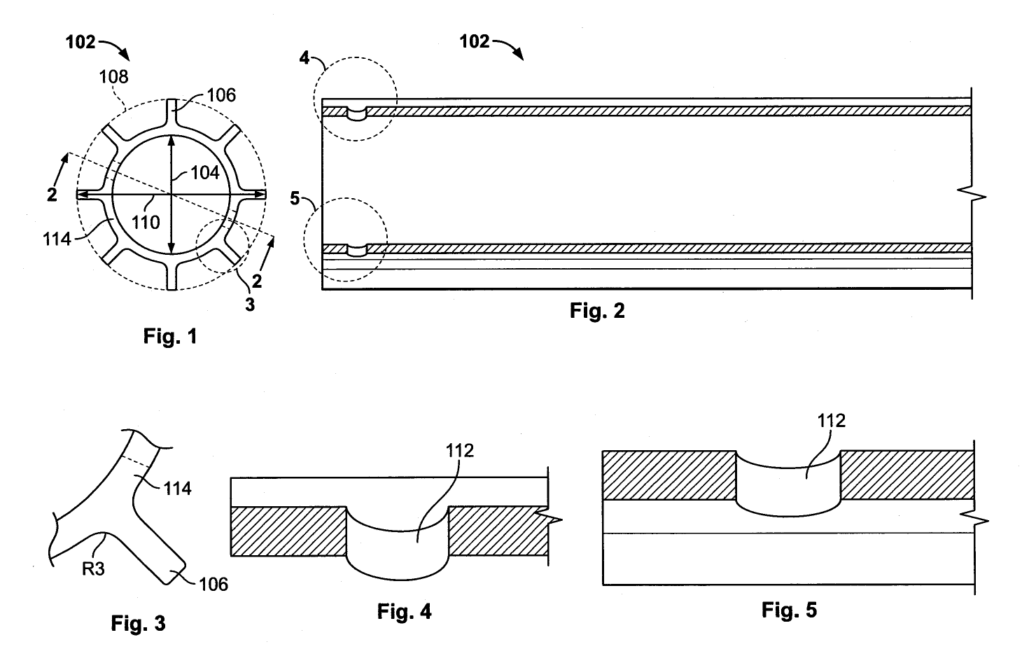

FIG. 1 generally shows a reinforcing member 102 according to an embodiment of the present invention. In this embodiment, the reinforcing member 102 has a substantially tubular shape with an internal diameter 104. A plurality of reinforcing ribs 106, which extend in the longitudinal direction, are arranged on the outer wall of an annular element 114. In the arrangement shown in FIG. 1, a total of eight reinforcing ribs 106 are arranged and evenly distributed along the circumference 108 of the annular element 114 of the reinforcing member 102. The outer surfaces of these ribs define a circular outer circumference 108, with an external diameter 110, for example, 120 mm.

The reinforcing member 102 can be produced from plastic material, being extruded at a particularly low cost and cut to an appropriate length.

The external diameter 110 is selected in such a way that the necessary minimum internal diameter of the expansion element 116 (FIG. 20) into which the reinforcing member 102 is introduced can always be maintained. The reinforcing member 102 is able to protect an expansion element 116 from collapse and deformation for a period of time, for example up to three years, even at an increased temperature.

According to an embodiment of the present invention, the expansion element 116, which produces the actual expansion of the resilient sheath 202 (FIG. 19), is a spiral holdout which is formed by a flat strip, wound in a helix so as to take on a tubular shape. By exerting a tensile force on an outwardly guided end of this strip, the holdout can be continuously removed for the actual assembly of the resilient sheath 202. For a person skilled in the art, however, it is clear that the arrangement according to the invention may also be applicable to other expansion element technologies. For example, the expansion element 116 could be collapsed by removing a seam region or be produced from a brittle material which can be removed after being broken into pieces.

The shape of the reinforcing member 102, shown in FIG. 1 to 5, is an advantageous configuration in particular for application in expansion elements 116 with internal diameters of approximately 80 mm, this configuration being optimally adapted to the forces which arise by varying the number of reinforcing ribs 106, the wall thickness and the length of the reinforcing ribs 106, the internal diameter 104 of the annular element 114 and the thickness of the annular element 114.

According to the invention, the reinforcing member 102 is constructed in such a way that it can be removed from an expansion element 116 before the assembly of a cable sleeve, without being destroyed. This prevents the support element 100 from deforming, and it further ensures that the pre-expanded cable sleeve can quickly be brought into a state such that it can be assembled. The intact reinforcing member 102 can then be used again for a new application.

According to the invention, the contact surface along the outer circumference 108 is kept as small as possible, so that the reinforcing member 102 can be removed immediately before the actual assembly without being destroyed. Additionally, the surface configuration of this contact surface with the expansion element 116 is optimized accordingly. It has been found that a surface quality “as extruded” delivers better results if there is subsequent lubrication with grease, with the grease being the type used in conventional connection elements and rejacketing sleeves.

To minimize the amount of material used for the reinforcing member 102, an optimum value for the following parameters must be found in combination with the respective expansion element 116 to be supported: the number of reinforcing ribs 106: the wall thickness and the length of the reinforcing ribs 106, the internal diameter of the annular element 114, the effective contact surface between the reinforcing ribs 106 and the inner surface of the annular element 114, the surface structure in these assembly regions and the possibility of lubrication between the elements in the contact regions.

In order to facilitate easier grip for an operator, the reinforcing member 102 includes two apertures 112, which may lie opposite one another, in the vicinity of an edge region of the annular element 114. As is evident from viewing these figures in conjunction with FIG. 19 to 21, a pull-strip 118, on which an assembler can exert a tensile force to remove the reinforcing member 102, can be threaded through these apertures 112. The apertures 112, for example, may be drilled into the reinforcing member 102, along the edge region of the annular element 114. A cable strap, for example, is suitable as a pull-strip 118. Alternatively, however, any other actuation elements may be used, such as metal or plastic material rods.

If a smaller external diameter 110 is required, the number of reinforcing ribs 106 can be reduced. Depending on the mechanical load exerted by the pre-stretched elements of a cable sleeve, the width of the reinforcing ribs 106 can also be reduced.

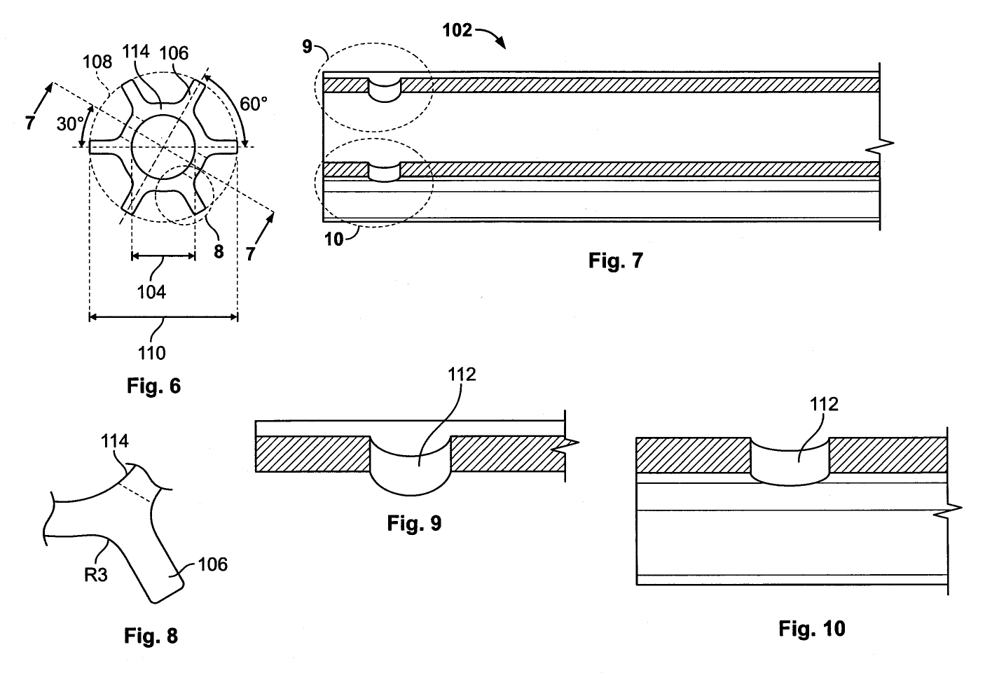

An example of a further embodiment of this type of reinforcing member 102 is shown in FIGS. 6 to 10. In this case, a total of six reinforcing ribs 106 are evenly distributed along the circumference of the inner annular element 114 of the reinforcing member 102.

This arrangement is well-suited to outer diameters 110 of approximately 30 mm, for example. It is important in any case for the contact surface, between the reinforcing ribs 106 and the inner wall of the expansion element 116, to be large enough in order to prevent penetration of the reinforcing ribs 106 through the expansion element 116, or unintentionally opening the seam regions. At very small external diameters 110 of the reinforcing member 102, the annular element 114 can even be minimized, as long as it is not possible that the reinforcing ribs 106 could buckle. In such a situation, the reinforcing ribs 106 have a rounding of for example R 0.5 mm at the corners. This makes it possible to prevent buckling by the reinforcing rib 106 by the expansion element 116. The ratio between the height and wall thickness of the reinforcing ribs 106 is to be set in such a way, taking into account the transition radius R3 in FIG. 8, that the reinforcing ribs 106 cannot be bent out laterally as a result of the ovality of the expansion element 116.

Apertures 112, into which a suitable pull-strip 118 can be threaded in order to remove the reinforcing member 102 before assembly, are also provided in the embodiment shown here. According to the invention, two identical reinforcing members 102 may be introduced into a pre-expanded sheath from two sides, and be removed before assembly by being pulled in two mutually opposed directions. This reduces the frictional forces for each individual reinforcing member 102, because the effective length of the contact between the reinforcing member 102 and the expansion element 116 only accounts for half of the necessary total length in each case.

The diameter of the circumference 108 may be approximately the same size as, or in the alternative, smaller than a diameter of the expansion element 116. What is important is that the boundary values for the minimum internal diameter, as required for assembly, of the expansion element 116 are not exceeded and compromised. Specifically, if the diameter of the circumference 108 is too close to the internal diameter of the expansion element 116, it is possible that over time, the tensile forces which are required to remove the reinforcing member 102, before assembly, will become too high. For example, with an original expansion element 116 internal diameter of 83 mm, the diameter of the circumference 108 of the reinforcing member 102 may advantageously be approximately 80 mm.

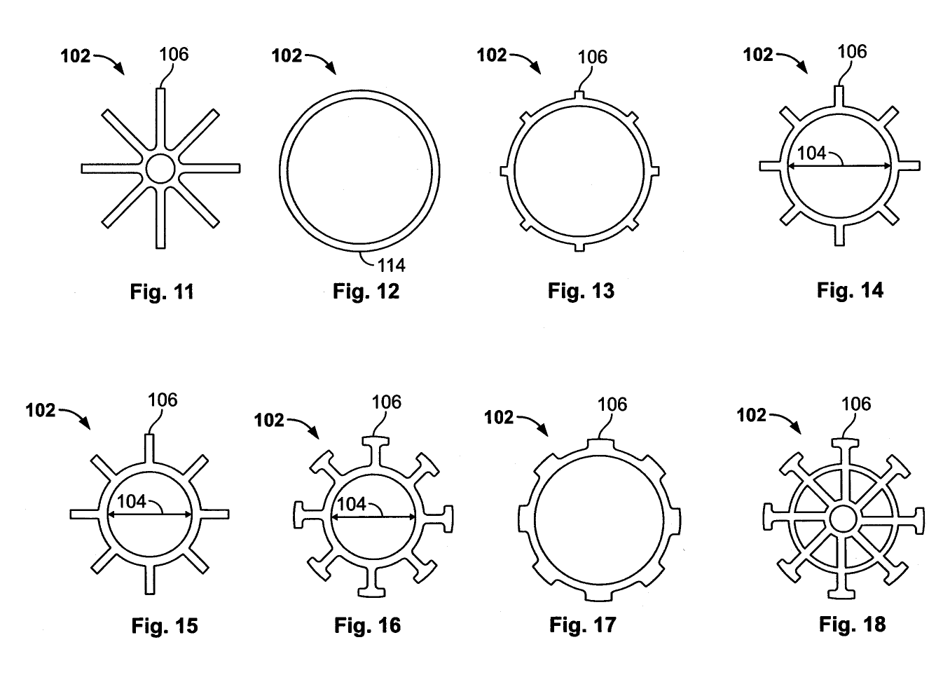

FIGS. 11 to 18 illustrate various possible shapes for the cross-sections of reinforcing members 102.

The various shapes shown are respectively prepared in order to optimize different force ratios and lengths of sheaths to be expanded.

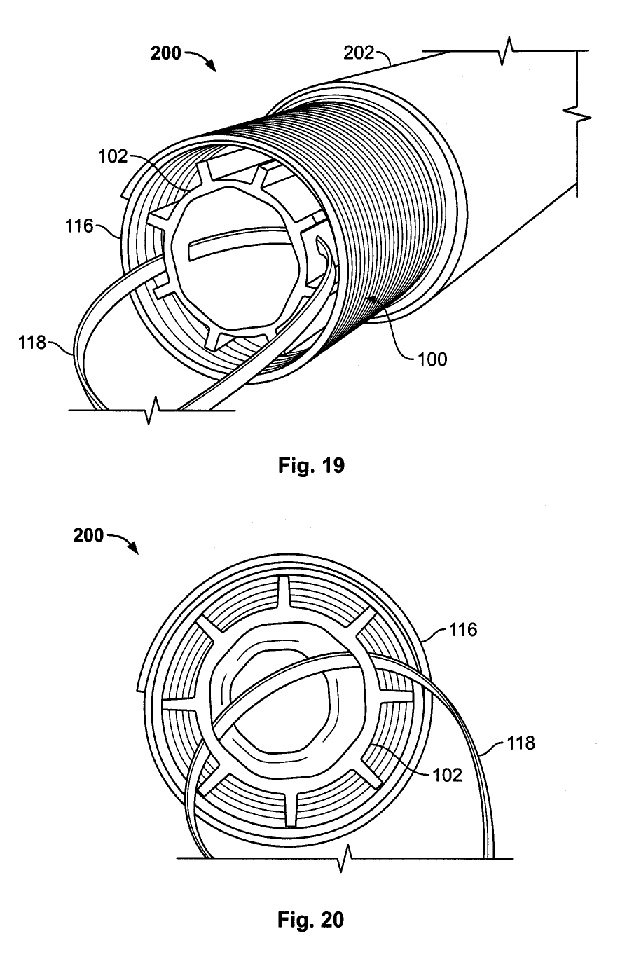

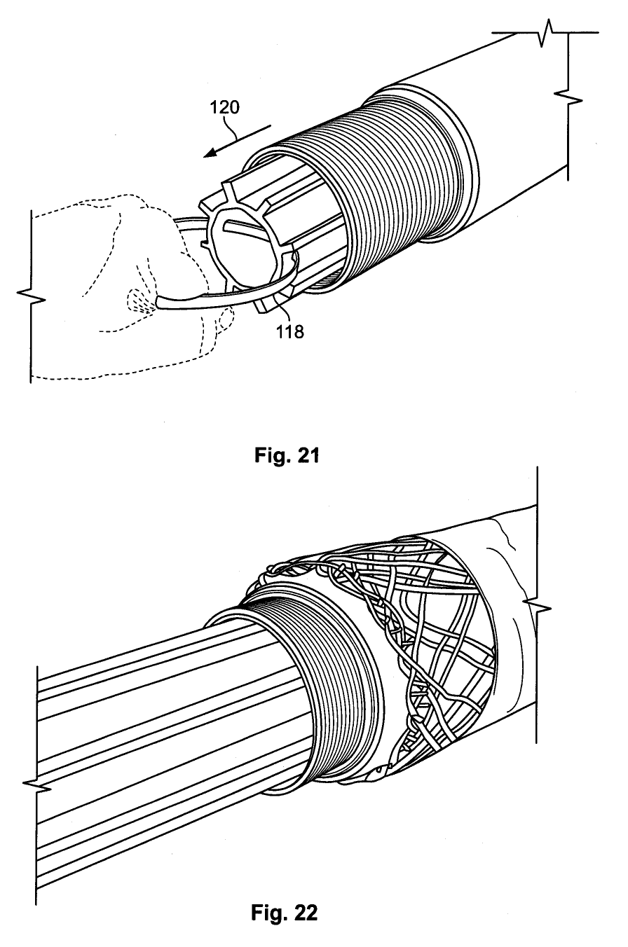

It is important on the one hand that the internal diameter of the expansion element 116 is maintained, but on the other hand that the tensile forces used when removing the reinforcing member 102 are low enough that an assembler can perform this task a number of times each day without difficulty. FIGS. 16 and 18 show reinforcing ribs 106 with enlarged contact surfaces, while the reinforcing ribs 106 in FIG. 18 include additional support for the annular element 114, in order to reduce the wall thickness.

To facilitate the removal of the reinforcing member 102, a removal mechanism may be arranged on the reinforcing member 102. This may, for example, be a pull-strip 118 which is guided through corresponding apertures 112 in the reinforcing member 102. A pull-strip 118 of this type provides a comparatively simple and low-cost type of removal mechanism.

To facilitate the removal of the reinforcing member 102, the reinforcing member 102 may be provided with a lubricant on the outer wall thereof so as to reduce the friction with the inner wall of the expansion element 116.

FIGS. 19 and 20 show a construction set 200 for a cable sleeve in the mountable state. The complete construction set 200 includes a resilient sheath 202, which is arranged pre-expanded on a support element 100. According to the invention, the support element 100 includes an expansion element 116 and a reinforcing member 102. The expansion element 116 is in this case formed by a known standard spiral holdout. The reinforcing member 102 is constructed as shown in FIG. 1. A pull-strip 118, for example a cable jacket, is pulled through the apertures 112.

The arrangement shown in this case is dimensionally stable as a construction set 200 for at least three years even at elevated temperature.

The preparation for assembly will now be described with reference to FIGS. 21 and 22. As shown in FIG. 21, an assembler grips the pull-strip 118 and exerts a tensile force in the longitudinal direction 120. This means that the reinforcing member 102 slides out of the expansion element 116 and can be removed without being destroyed. The reinforcing member 102 can then be re-used, being positioned in with a further expansion element 116. According to the invention, two identical reinforcing members 102, which are each of half the required length, may be provided and removed in the direction 120 and in the opposite direction before the expanded sheath 202 is assembled. Naturally, it is also possible to use more than two identical or differently shaped reinforcing members 102.

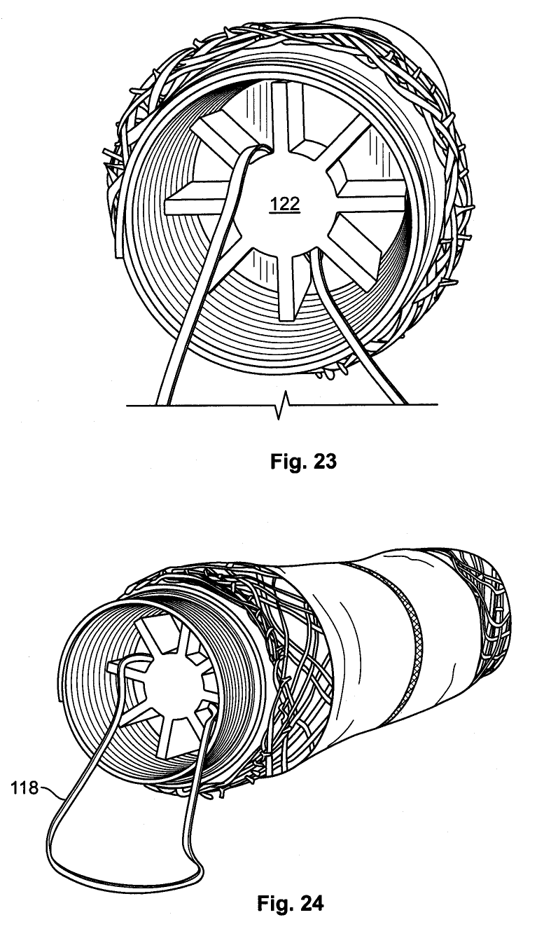

FIGS. 23 and 24 show a construction set 200 having reinforcing member 102, wherein the annular element 114 is a closed core 122. A through-hole allows the pull-strip 118 to be threaded through the closed core 122 in this case.

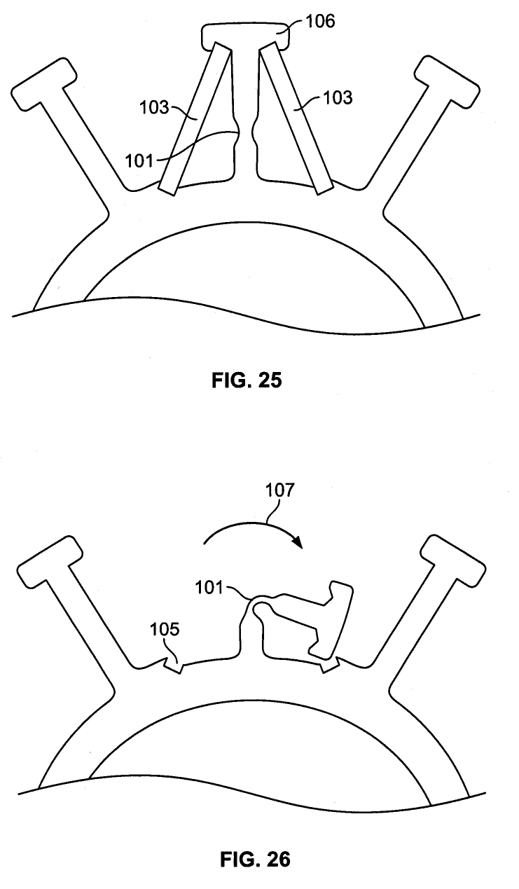

To reduce the frictional forces which come into effect when the reinforcing member 102 is removed from the expansion element 116, various modifications can be made to the reinforcing member 102 and will be explained in detail in the following with reference to FIGS. 25 to 28.

To reduce the friction between the outer surface of the reinforcing member 102 and the inner wall of the expansion element 116 before removing the reinforcing member 102, one or more reinforcing ribs 106 may, as is shown in FIGS. 25 and 26, be configured in such a way as to be movable. This can be affected, as is shown in these figures, by a deformable section 101 that enables folding of the reinforcing rib 106. So that the reinforcing rib 106 only folds immediately before removal. Two support legs 103 may be provided, as shown in FIG. 25. The support legs 103, being held by corresponding grooves 105 on the annular element 114, are positioned to lie against the reinforcing rib 106 on one side and sit in the corresponding grooves 105 of the annular element 114 on the other side. When the reinforcing member 102 is to be removed, an assembler initially pulls the support legs 103 out in the longitudinal direction, in such a way that the reinforcing rib 106 folds about the deformable section 101 in a lateral direction 107 (or in the opposite direction, depending on which of the support legs 103 are removed first). In this way, the contact surface between the reinforcing member 102 and the expansion element 116 is reduced and the frictional forces are thus reduced. The reinforcing member 102 can be removed more easily and with less effort.

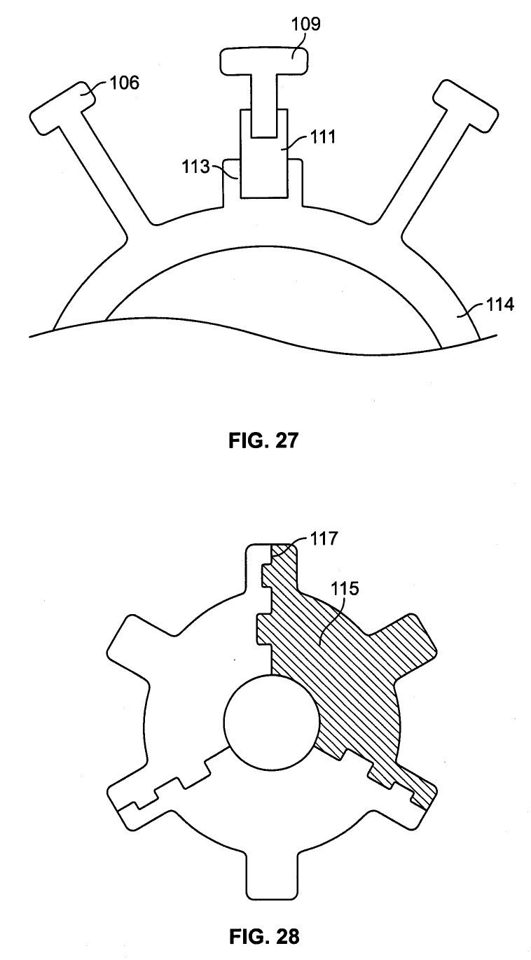

FIG. 27 shows a further embodiment of a reinforcing member 102, in which before the removal of the reinforcing member 102 from the expansion element 116, the effective contact surface is reduced by rendering one or more reinforcing ribs 106 ineffective. As shown in FIG. 27, this takes place when the reinforcing rib 106 is configured to be removable, rather than being an integral formation of the annular element 114. In the embodiment shown, selected reinforcing ribs 106 are formed by a reinforcing finger 109 and an adapter 111. The adapter 111 is held so as to be longitudinally displaceable in a groove 113 arranged on the annular element 114. The reinforcing rib 106 formed by the two elements 109, 111 is configured in such a way as to be able to receive the forces in a radial direction without being bent out laterally.

Before the removal of the reinforcing member 102, it is now possible for the reinforcing finger 109 to be removed either alone or together with the adapter 111 by pulling in the longitudinal direction, significantly reducing the friction as in the case of FIG. 26.

In FIGS. 25 and 26, as well as in FIG. 27, the removable reinforcing ribs 106 should be arranged along the circumference at an angle of 90°. All boundary surfaces should be provided with lubricant. In principle, the adapter 111 may also be held fixed in the groove 113, for example by an adhesive connection.

A further possibility for reducing the forces required to pull out the reinforcing member 102 involves dividing up the reinforcing member 102 in the longitudinal direction. This is shown schematically by means of the cross-sectional schematic, shown in FIG. 28.

The reinforcing member 102 is formed by three interconnected reinforcing member segments 115. The friction between the internal contact surfaces 117 at which these segments 115 are interconnected can be reduced by a lubricant. By pulling in the longitudinal direction, each segment 115 can be removed, one after another, and the forces to be applied remain low provided that the internal contact surfaces 117 between the segments have sufficiently low friction.

In the embodiment shown in FIG. 28, the reinforcing member 102 is formed by three identical segments 115. However, it is clear to the person skilled in the art that other types of radial segmentation with seam regions extending in the longitudinal direction are also possible.

The internal contact surfaces 117, at which these segments 115 are interconnected, must not lie against one another fully in a positive connection over the entire contact surface, but may contact one another only at the lugs in order to reduce the frictional forces. The friction between them may also be reduced using a lubricant. Moreover, the segments 115 need not necessarily be identical. In particular, at least one element may include contact surfaces at an angle deviating from the radial direction, so as additionally to reduce the frictional forces and thus the tensile forces on this element. Non-identical segments 115 may also differ as regards the number and formation of the ribs for the purposes of reducing the tensile forces.

To prevent, what is known as cold welding, between the reinforcing member 102 and the expansion element 116, it is advantageous to produce these two components from different materials. The reinforcing member 102 may be produced using a low-cost thermoplastic material, such as acrylonitrile butadiene styrene (ABS). This extruded reinforcing member 102 may in addition be co-extruded with an outer layer of a low-friction material. One material of this type is polytetrafluoroethylene (PTFE, “Teflon”), for example.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A support element for a resilient sheath, comprising:
a tubular expansion element, engagable with an inner wall of the resilient sheath and formed to hold the resilient sheath in a pre-assembled radially expanded state;
a reinforcing member, which in the pre-assembled radially expanded state is at least partially received in, and removable from, an internal diameter of the expansion element without being compromised.

2. The support element according to claim 1, wherein the reinforcing member comprises an annular element which extends in the longitudinal direction, the annular element is provided with a plurality of reinforcing ribs on the outer wall thereof which extend substantially in the longitudinal direction.

3. The support element according to claim 2, wherein the reinforcing ribs are in contact with the expansion element.

4. The support element according to claim 2, wherein the annular element is a closed core.

5. The support element according to claim 3, wherein the annular element is a closed core.

6. The support element according to claim 2, wherein at least one reinforcing rib is configured so as to be removable.

7. The support element according to claim 2, wherein at least one reinforcing rib is configured so as to be deformable.

8. The support element according to claim 7, wherein at least one movable reinforcing rib comprises a deformable section.

9. The support element according to claim 8, wherein the deformable section extends in the longitudinal direction and about which the reinforcing rib is pivotable.

10. The support element according to claim 9, wherein the at least one movable reinforcing rib is fixed in the delivery state by at least one support leg.

11. The support element according to claim 1, wherein the reinforcing member is divided at least once in a direction transverse to the longitudinal axis thereof.

12. The support element according to claim 2, wherein the reinforcing member is divided at least once in a direction transverse to the longitudinal axis thereof.

13. The support element according to claim 1, wherein the reinforcing member is divided up into at least two segments in a direction along the longitudinal axis thereof.

14. The support element according to claim 2, wherein the reinforcing member is divided up into at least two segments in a direction along the longitudinal axis thereof.

15. The support element according to claim 1, wherein the reinforcing member is provided with a removal mechanism for actuation by an assembler.

16. The support element according to claim 15, wherein the removal mechanism comprises a pull-strip which is guided through apertures in the reinforcing member.

17. The support element according to claim 1, wherein the expansion element is formed by a flat strip which is wound in a helix so as to take on a tubular shape.

18. The support element according to claim 1, wherein the reinforcing member is produced from plastic material by extrusion.

19. The support element according to claim 1, wherein the reinforcing member is provided with a lubricant at contact surfaces which are in contact with the expansion element.

20. The support element according to claim 1, wherein the expansion element and the reinforcing member are produced from different materials.

21. A construction set, comprising
at least one resilient sheath which is arranged pre-expanded on a support element;
an expansion element on the support element adapted to contact an inner wall of a resilient sheath and formed in such a way as to hold the resilient sheath in a pre-assembled radially expanded state;
a reinforcing member at least partially received in the expansion element to support the internal diameter of the expansion element and removable from the expansion element before the assembly of the resilient sheath without being compromised.

22. The construction set according to claim 21, wherein the resilient sheath is a cover for a cable connection.

23. A method for assembling a resilient sheath, comprising the following steps:
preparing a construction set having at least one resilient sheath which is arranged pre-expanded on a support element, the support element having a tubular expansion element and a reinforcing member;
removing the reinforcing member by applying tensile force in the longitudinal direction;
positioning the resilient sheath, which is pre-expanded on the support element, adjacent to a region which is to be covered in order to allow an electrical connection to be produced;
after the electrical connection has been produced, sliding the resilient sleeve, which is pre-expanded on the support element, over the region which is to be covered;
removing the expansion element to fix the resilient sheath in a final mounted state.

24. The method according to claim 23, wherein the reinforcing member is formed in two or more parts and is pulled out of the expansion element by pulling in two mutually opposed directions.

25. The method according to claim 23, wherein the expansion element is formed by a flat strip, which is wound in a helix so as to take on a tubular shape, and removed from the resilient sheath by pulling out the strip.

26. The method according to claim 24, wherein the expansion element is formed by a flat strip, which is wound in a helix so as to take on a tubular shape, and removed from the resilient sheath by pulling out the strip.

27. The method according to claim 23, wherein the reinforcing member is loosened by impacts or by a rotational movement before being pulled out.

28. The method according to claim 26, wherein the reinforcing member is loosened by impacts or by a rotational movement before being pulled out.
